(19) United States
(12) Patent Application Publication
(10) Pub. No.: US 2026/0098173 A1
(43) Pub. Date: Apr. 9, 2026

(54) PIGMENT DISPERSION LIQUID, INKJET INK, METHOD OF PRODUCING A PIGMENT DISPERSION LIQUID, AND METHOD OF PRODUCING AN INKJET INK

(71) Applicant: KYOCERA DOCUMENT SOLUTIONS INC., OSAKA (JP)

(72) Inventors: RYOTARO KOMADA, OSAKA (JP); KAZUKI SASE, OSAKA (JP)

(21) Appl. No.: 19/348,738

(22) Filed: Oct. 2, 2025

(30) Foreign Application Priority Data
Oct. 7, 2024 (JP) 2024-175981

(51) Int. Cl. C09D 17/00; C09D 7/80; C09D 11/107; C09D 11/30

(52) U.S. Cl. CPC C09D 17/001; C09D 7/80; C09D 11/107; C09D 11/30

(57) ABSTRACT

A pigment dispersion liquid includes: an aqueous medium, and a pigment dispersion dispersed in the aqueous medium. The pigment dispersion includes a pigment and a specific resin. The specific resin has a cross-linked structure in which a pigment dispersion resin including a copolymer of a plurality of specific monomers is cross-linked by a cross-linking agent. The plurality of specific monomers includes 60 mass % or more and 80 mass % or less of cyclohexyl (meth)acrylate and 22 mass % or more and 30 mass % or less of (meth)acrylic acid. The copolymer has an acid value of 170 mg KOH/g or more and 230 mg KOH/g or less, a neutralization rate of 40% or more and 100% or less, and a mass average molecular weight of 3000 or more and 18000 or less. The cross-linking agent includes a plurality of epoxy groups and at least one hydroxy group in one molecule, and has water solubility of 80 mass % or more. The specific resin has a cross-linking rate of 30% or more and 70% or less.

### CROSS-REFERENCE TO RELATED PATENT APPLICATION

This application claims the benefit of Japanese Priority Patent Application JP 2024-175981 filed Oct. 7, 2024, the entire contents of which are incorporated herein by reference.

### FIELD OF THE DISCLOSURE

The present disclosure relates to a pigment dispersion liquid, an inkjet ink, a method of producing a pigment dispersion liquid, and a method of producing an inkjet ink.

### BACKGROUND OF THE DISCLOSURE

For inkjet recording apparatuses, for example, aqueous inks including a pigment and an aqueous medium are used. With such inks, preservation stability is difficult to achieve if the pigment is likely to agglomerate or settle. In this regard, Japanese Patent No. 5532809, WO 2012/118078, Japanese Patent No. 7265353, and Japanese Patent No. 7141791 disclose a technology in which a pigment dispersion resin for enhancing dispersibility of pigments is blended in an ink.

In the ink disclosed in Japanese Patent No. 5532809, a pigment dispersion resin that is copolymerized with 8 to 98 weight % of cyclohexyl acrylate and/or benzyl acrylate, 1 to 31 weight % of methacrylic acid, and 1 to 25 weight % of acrylic acid as main components and has an acid value of 10 to 200 mg KOH/g is blended.

In the ink disclosed in WO 2012/118078, a pigment dispersion resin including 10 to 96 weight % of cyclohexylmethacrylate, 1 to 90 weight % of an acrylic acid unit, and 1 to 25 weight % of a styrene unit is blended.

The ink disclosed in Japanese Patent No. 7265353 includes a pigment dispersion resin having a configuration in which a polymer particle coating a pigment is cross-linked by a cross-linking agent, and includes a water-insoluble polymer including a structural unit derived from (meth)acrylic acid and a structural unit derived from (meth)acrylic acid ester.

The ink disclosed in Japanese Patent No. 7141791 includes a pigment dispersion resin having a configuration in which a copolymer including a structural unit derived from one or more types of components selected from the group consisting of a styrene monomer, an aromatic group-containing acrylate, and a styrene macromonomer and a structural unit derived from one or more types of components selected from the group consisting of acrylic acid and methacrylic acid is cross-linked.

### SUMMARY OF THE DISCLOSURE

According to an embodiment of the present disclosure, there is provided a pigment dispersion liquid, including: an aqueous medium; and a pigment dispersion dispersed in the aqueous medium.

The pigment dispersion includes a pigment and a specific resin.

The specific resin has a cross-linked structure in which a pigment dispersion resin including a copolymer of a plurality of specific monomers is cross-linked by a cross-linking agent.

The plurality of specific monomers includes 60 mass % or more and 80 mass % or less of cyclohexyl (meth)acrylate and 22 mass % or more and 30 mass % or less of (meth)acrylic acid.

The copolymer of a plurality of specific monomers has an acid value of 170 mg KOH/g or more and 230 mg KOH/g or less, a neutralization rate of 40% or more and 100% or less, and a mass average molecular weight of 3000 or more and 18000 or less.

The cross-linking agent includes a plurality of epoxy groups and at least one hydroxy group in one molecule and has water solubility of 80 mass % or more.

The specific resin has a cross-linking rate of 30% or more and 70% or less.

An inkjet ink according to an embodiment of the present disclosure includes: the above pigment dispersion liquid.

A method of producing a pigment dispersion liquid according to an embodiment of the present disclosure includes: a dispersion step of dispersing a pigment and a pigment dispersion resin in an aqueous medium to prepare an intermediate pigment dispersion liquid; and a cross-linking step of preparing a pigment dispersion liquid by adding a cross-linking agent to the intermediate pigment dispersion liquid and cross-linking the pigment dispersion resin on a surface of the pigment to obtain a specific resin.

The pigment dispersion resin includes a copolymer of a plurality of specific monomers.

The plurality of specific monomers includes 60 mass % or more and 80 mass % or less of cyclohexyl (meth)acrylate and 22 mass % or more and 30 mass % or less of (meth)acrylic acid.

The copolymer of a plurality of specific monomers has an acid value of 170 mg KOH/g or more and 230 mg KOH/g or less, a neutralization rate of 40% or more and 100% or less, and a mass average molecular weight of 3000 or more and 18000 or less.

The cross-linking agent includes a plurality of epoxy groups and at least one hydroxy group in one molecule and has water solubility of 80 mass % or more.

The specific resin has a cross-linking rate of 30% or more and 70% or less.

A method of producing an inkjet ink according to an embodiment of the present disclosure includes: a dispersion step of dispersing a pigment and a pigment dispersion resin in an aqueous medium to prepare an intermediate pigment dispersion liquid; a cross-linking step of preparing a pigment dispersion liquid by adding a cross-linking agent to the intermediate pigment dispersion liquid and cross-linking the pigment dispersion resin on a surface of the pigment to obtain a specific resin; and an ink preparation step of adding a water-soluble organic solvent and water to the pigment dispersion liquid to prepare an inkjet ink.

The pigment dispersion resin includes a copolymer of a plurality of specific monomers.

The plurality of specific monomers includes 60 mass % or more and 80 mass % or less of cyclohexyl (meth)acrylate and 22 mass % or more and 30 mass % or less of (meth)acrylic acid.

The copolymer of a plurality of specific monomers has an acid value of 170 mg KOH/g or more and 230 mg KOH/g or less, a neutralization rate of 40% or more and 100% or less, and a mass average molecular weight of 3000 or more and 18000 or less.

The cross-linking agent includes a plurality of epoxy groups and at least one hydroxy group in one molecule and has water solubility of 80 mass % or more.

The specific resin has a cross-linking rate of 30% or more and 70% or less.

### DETAILED DESCRIPTION OF THE EXEMPLARY EMBODIMENTS

In inkjet recording apparatuses, the contact area between ink and the atmosphere increases near the recording head, making the ink more likely to dry. For this reason, in the ink present near the recording head, the pigment dispersion resin is more likely to separate from the surface of the pigment due to the increase in concentration of the water-soluble organic solvent as the drying progresses. As a result, when the agglomeration of pigments progresses in the ink present near the recording head, nozzle clogging in the recording head is more likely to occur.

In this regard, since the pigment dispersion resin is not bound to the pigment in the inks disclosed in Japanese Patent No. 5532809 and WO 2012/118078, the pigment dispersion resin tends to separate from the surface of the pigment near the recording head. Further, in the ink disclosed in Japanese Patent No. 7265353, the viscosity tends to increase excessively near the recording head due to the influence of the water-insoluble polymer, making nozzle clogging in the recording head more likely to occur.

Further, in the ink disclosed in Japanese Patent No. 7141791, the effect of suppressing the agglomeration of pigments is difficult to achieve when a quinacridone pigment such as Pigment Red 122 or an azo pigment such as Pigment Yellow 74 is used as a pigment, although the effect of suppressing the agglomeration of pigments is achieved when Pigment Black 7 or Pigment Blue 15:3 is used as a pigment.

In view of the circumstances as described above, it is an object of the present disclosure to provide a technology capable of achieving high preservation stability and suppressing the occurrence of nozzle clogging in the recording head in an inkjet ink.

Embodiments of the present disclosure will be described. Note that in the present disclosure, “acrylic” and “methacrylic” will be collectively referred to as “(meth)acrylic”, i.e., “(meth)acrylic” includes both “acrylic” and “methacrylic”.

### [Configuration of Inkjet Ink]

### (Schematic Configuration)

An inkjet ink according to this embodiment (hereinafter, referred to simply also as an “ink”) includes an aqueous medium, and a pigment dispersion dispersed in the aqueous medium. The pigment dispersion includes a pigment, and a specific resin coating the pigment.

In the ink according to this embodiment, the specific resin has a cross-linked structure in which a pigment dispersion resin including a copolymer of a plurality of specific monomers is cross-linked by a cross-linking agent, the pigment dispersion resin having the effect of suppressing the agglomeration of pigments in the aqueous medium by being adsorbed on the surface of the pigment. In the ink according to this embodiment, since the specific resin coating the pigment is bound to the surface of the pigment by having a cross-linked structure, it is possible to prevent the specific resin from separating from the surface of the pigment. In the ink according to this embodiment, since a strong binding force of the specific resin to the surface of the pigment can be achieved while maintaining the effect of suppressing the agglomeration of pigments by the pigment dispersion resin, the dispersed state of the pigment dispersion in the aqueous medium is easily maintained.

The ink according to this embodiment includes a copolymer of a plurality of specific monomers as a pigment dispersion resin. The plurality of specific monomers (a total of 100 mass %) includes 60 mass % or more and 80 mass % or less of cyclohexyl (meth)acrylate and 22 mass % or more and 30 mass % or less of (meth)acrylic acid, and may further include (meth)acrylic acid ester other than cyclohexyl (meth)acrylate. Further, the copolymer of a plurality of specific monomers has an acid value of 170 mg KOH/g or more and 230 mg KOH/g or less, a neutralization rate of 40% or more and 100% or less, and a mass average molecular weight (Mw) of 3000 or more and 18000 or less.

The ink according to this embodiment may include, as a pigment dispersion resin, a resin other than the above copolymer of a plurality of specific monomers, e.g., a styrene-(meth)acrylic acid copolymer. That is, in the ink according to this embodiment, the specific resin may have a cross-linked structure in which a copolymer of a plurality of specific monomers and a styrene-(meth)acrylic acid copolymer are cross-linked by a cross-linking agent. As a result, in the ink according to this embodiment, it is possible to effectively achieve the effect of suppressing the agglomeration of pigments in the aqueous medium. The styrene-(meth)acrylic acid copolymer is favorably a copolymer of α-methylstyrene, styrene, (meth)acrylic acid, and a nonionic monomer.

In the ink according to this embodiment, the cross-linking agent used for cross-linking the pigment dispersion resin is an epoxy group-containing cross-linking agent that includes a plurality of epoxy groups and at least one hydroxy group in one molecule and has water solubility of 80 mass % or more. The water solubility (mass %) of the cross-linking agent refers to the ratio of the mass of the cross-linking agent dissolved in water when 10 g of the cross-linking agent is mixed with 90 g of water.

In the ink according to this embodiment, the specific resin has a cross-linking rate of 30% or more and 70% or less. The cross-linking rate refers to the percentage of the number of moles of repeating units having a cross-linked structure when the total number of moles of repeating units derived from the monomer having a functional group that reacts with the cross-linking agent in the specific resin is 100%. The cross-linking rate of the specific resin according to this embodiment is defined by an apparent cross-linking rate calculated from the equivalent number of moles of carboxy groups of the specific resin and the equivalent number of moles of cross-linked functional groups of the cross-linking agent and is calculated using the following formula.

Cross-linking rate (%)=100×(the equivalent number of moles of cross-linked functional groups of the cross-linking agent/the equivalent number of moles of carboxy groups of the specific resin)

The uses of the ink according to this embodiment are not particularly limited. However, for example, the ink according to this embodiment can be used to form an image on a permeable recording medium or a non-permeable recording medium. In particular, the ink according to this embodiment is suitable for forming an image on a permeable recording medium. The permeable recording medium only needs to be a recording medium with high permeability of ink. Examples of such a recording medium include printing paper and a medium using a fiber as a raw material (e.g., a fabric). Examples of the printing paper include plain paper, copy paper, recycled paper, thin paper, thick paper, and glossy paper.

By having the above-mentioned configuration, the ink according to this embodiment is capable of achieving high preservation stability and suppressing the occurrence of nozzle clogging in the recording head. The reason for this is presumed to be as follows.

The ink according to this embodiment includes a pigment dispersion including a pigment and a specific resin. The pigment is a component having low dispersibility in the aqueous medium when used alone. Meanwhile, the specific resin is a component having an excellent affinity with the aqueous medium. By including the pigment and the specific resin, the pigment dispersion exhibits excellent dispersibility in the aqueous medium. Further, by forming the specific resin with the monomer composition described above, more excellent dispersibility of the pigment dispersion in the aqueous medium is achieved. Further, in the specific resin, by keeping the cross-linking rate at 70% or less, the favorable dispersibility of the pigment dispersion in the aqueous medium is maintained. In this way, the ink according to this embodiment is capable of achieving high preservation stability and suppressing the occurrence of nozzle clogging in the recording head.

Further, the specific resin is cross-linked by a cross-linking agent having a plurality of epoxy groups and has a cross-linked structure that is less susceptible to the water-soluble organic solvent. For this reason, the specific resin does not easily separate from the surface of the pigment even if the drying of the ink had progressed and the concentration of the water-soluble organic solvent has increased. As a result, in the ink according to this embodiment, it is possible to suppress the agglomeration of pigments exposed due to the separation of the specific resin from the pigment. In the specific resin, by setting the cross-linking rate to 30% or more, the effect of suppressing the separation from the surface of the pigment is favorably achieved. Therefore, in the ink according to this embodiment, the effect of improving the dispersibility in the aqueous medium by the specific resin is easily maintained.

### (Pigment Dispersion)

The pigment dispersion includes a pigment and a specific resin. The pigment dispersion includes, for example, a core including a pigment and a specific resin coating the core. In the pigment dispersion, the total content of the pigment and the specific resin is favorably 90 mass % or more, more favorably 100 mass %. In the ink according to this embodiment, the pigment dispersion favorably has a volume median diameter of 30 nm or more and 200 nm or less, more favorably 80 nm or more and 140 nm or less, from the viewpoint of optimizing color density, hue, or stability.

In the ink according to this embodiment, the content of the pigment dispersion is favorably 5.0 mass % or more and 30.0 mass % or less, more favorably 8.0 mass % or more and 15.0 mass % or less. In the ink according to this embodiment, by setting the content of the pigment dispersion to 5.0 mass % or more, an image with favorable image density can be easily formed on a recording medium. Further, in the ink according to this embodiment, by keeping the content of the pigment dispersion at 30.0 mass % or less, sufficient fluidity as an ink is easily achieved.

### (Pigment)

Examples of the pigment that can be used in the ink according to this embodiment include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink according to this embodiment, the content of the pigment is favorably 3.0 mass % or more and 20.0 mass % or less, more favorably 7.0 mass % or more and 12.0 mass % or less. In the ink according to this embodiment, the content of the pigment in the pigment dispersion is favorably 50 mass % or more and 90 mass % or less, more favorably 70 mass % or more and 80 mass % or less.

### (Specific Resin)

In the ink according to this embodiment, the copolymer of a plurality of specific monomers constituting the specific resin has a mass average molecular weight of 3000 or more and 18000 or less. In the ink according to this embodiment, by setting the mass average molecular weight of the copolymer of a plurality of specific monomers constituting the specific resin to be within this range, the efficiency of coating the surface of the pigment with the specific resin is improved, and the pigment dispersion liquid and the ink are easily maintained at appropriate viscosity.

In the ink according to this embodiment, the specific resin has a cross-linking rate of 30% or more and 70% or less, favorably 40% or more and 60% or less. In the ink according to this embodiment, by setting the cross-linking rate of the specific resin to 30% or more, the separation of the specific resin from the surface of the pigment is more easily suppressed. Further, in the ink according to this embodiment, by setting the cross-linking rate of the specific resin to 70% or less, the effect of suppressing the agglomeration of pigments in the aqueous medium by the copolymer of a plurality of specific monomers before cross-linking is easily maintained.

In the ink according to this embodiment, the content of the specific resin is favorably 0.5 mass % or more and 10.0 mass % or less, more favorably 2.0 mass % or more and 4.0 mass % or less. In the pigment dispersion in the ink according to this embodiment, the content of the specific resin is favorably 10 mass % or more and 50 mass % or less, more favorably 20 mass % or more and 30 mass % or less.

### (Cross-Linking Agent)

In the ink according to this embodiment, the number of epoxy groups in the molecule of the cross-linking agent used for cross-linking the pigment dispersion resin is 2 or more, favorably 3 or more. This makes it easier to obtain a sufficient cross-linking rate in the specific resin. Further, in the ink according to this embodiment, the number of hydroxy groups in the molecule of the cross-linking agent used for cross-linking the pigment dispersion resin is 1 or more, favorably 2 or more. This improves the affinity of the specific resin with the aqueous medium, making it possible to more effectively suppress the occurrence of nozzle clogging in the recording head. Further, in the ink according to this embodiment, the water solubility of the cross-linking agent used for cross-linking the pigment dispersion resin is 80% or more, favorably 100%.

In the ink according to this embodiment, examples of the cross-linking agent that can be used for cross-linking the pigment dispersion resin include sorbitol polyglycidylether, glycerol polyglycidylether, diglycerol polyglycidylether, and polyglycerol polyglycidylether. Further, in the ink according to this embodiment, examples of the product of the cross-linking agent that can be used for cross-linking the pigment dispersion resin include DENACOL (registered trademark) EX-614B, DENACOL (registered trademark) EX-313, DENACOL (registered trademark) EX-421, DENACOL (registered trademark) EX-512, and DENACOL (registered trademark) EX-521, which are cross-linking agents manufactured by Nagase ChemteX Corporation.

In the ink according to this embodiment, the epoxy equivalent (g/eq.) of the cross-linking agent used for cross-linking the pigment dispersion resin is favorably 100 or more and 10000 or less, more favorably 120 or more and 250 or less, from the viewpoint of causing it to efficiently react with the carboxy group of the pigment dispersion resin to enhance the dispersion stability of the pigment dispersion. When the amount of epoxy groups in the cross-linking agent is too large, the cross-linking does not efficiently progress, and the epoxy groups act as water-soluble groups instead in some cases. Further, when the amount of epoxy groups in the cross-linking agent is too small, the cross-linking points are insufficient, resulting in insufficient suppression of the separation of the specific resin from the surface of the pigment.

In the ink according to this embodiment, the cross-linking agent used for cross-linking the pigment dispersion resin favorably has a mass average molecular weight of 100 or more and 1500 or less from the viewpoints of ease of reaction and dispersion stability of the pigment dispersion.

### (Aqueous Medium)

The aqueous medium included in the ink according to this embodiment is a medium including water. The aqueous medium may function as a solvent or a dispersion medium. Specific examples of the aqueous medium include an aqueous medium that includes water and a water-soluble organic solvent. In the ink according to this embodiment, the content of water is favorably 25.0 mass % or more and 80.0 mass % or less, more favorably 35.0 mass % or more and 60.0 mass % or less.

Examples of the water-soluble organic solvent that can be used in the ink according to this embodiment include a glycol compound, a triol compound, a glycol ether compound, a lactam compound, a nitrogen-containing compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. As the glycol compound, ethylene glycol, diethylene glycol, 2-ethyl-1,2-hexanediol, 3-methyl-1,5-pentanediol, 1,3-propanediol, 1,5-pentanediol, or propylene glycol is favorable.

Examples of the triol compound include glycerin and 1,2,3-butanetriol.

Examples of the glycol ether compound include diethyl diglycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether. As the glycolether compound, triethylene glycol monobutylether is favorable.

Examples of the lactam compound include 2-pyrrolidone and N-methyl-2-pyrrolidone. As the lactam compound, 2-pyrrolidone is favorable.

Examples of the nitrogen-containing compound include 1,3-dimethylimidazolidinone, formamide, and dimethylformamide.

Examples of the acetate compound include diethylene glycol monoethyl ether acetate.

In the ink according to this embodiment, it is favorable to use at least one of a glycol compound, a triol compound, a glycol ether compound, or a lactam compound as a water-soluble organic solvent, and it is more favorable to use a mixed solvent shown in the following combinations (a) to (8).
Combination (a): ethylene glycol and diethyl diglycol
Combination (B): glycerin, triethylene glycol monobutyl ether, 3-methyl-1,5-pentanediol, and 2-pyrrolidone
Combination (y): triethylene glycol monobutyl ether, 2-pyrrolidone, 1,3-propanediol, and 1,5-pentanediol
Combination (8): 3-methyl-1,5-pentanediol, 1,2,3-butanetriol, 2-ethyl-1,2-hexanediol, and propylene glycol

In the ink according to this embodiment, the content of the water-soluble organic solvent is favorably 15.0 mass % or more and 50.0 mass % or less, more favorably 30.0 mass % or more and 40.0 mass % or less.

### (Surfactant)

The ink according to this embodiment favorably further includes a surfactant. The surfactant has the effect of enhancing the permeability (wettability) of the ink into the recording medium. Examples of the surfactant include an anionic surfactant, a cationic surfactant, and a nonionic surfactant. As the surfactant, a nonionic surfactant is favorable.

Examples of the nonionic surfactant include polyoxyethylene dodecylether, polyoxyethylene hexadecylether, polyoxyethylene nonylphenylether, polyoxyethylene sorbitan monooleate ether, monodecanoyl sucrose, and an ethylene oxide adduct of acetylene glycol. As the nonionic surfactant, an ethylene oxide adduct of acetylene glycol is favorable.

In the ink according to this embodiment, the content of the surfactant is favorably 0.05 mass % or more and 3.0 mass % or less, more favorably 0.1 mass % or more and 0.5 mass % or less.

### (Other Components)

In the ink according to this embodiment, components other than the above may be blended as necessary. For example, various additives such as a dissolution stabilizer, a moisturizing agent, a penetrating agent, an anti-drying agent, an antioxidant, a viscosity adjustor, a pH adjuster, and an antifungal agent may be blended in the ink according to this embodiment.

### [Configuration of Pigment Dispersion Liquid]

The pigment dispersion liquid according to this embodiment is used to prepare the ink according to this embodiment. The pigment dispersion liquid according to this embodiment includes an aqueous medium, and a pigment dispersion dispersed in the aqueous medium. The aqueous medium in the pigment dispersion liquid according to this embodiment is typically water. Further, the pigment dispersion in the pigment dispersion liquid according to this embodiment has the same configuration as that of the pigment dispersion in the ink according to this embodiment.

### [Method of Producing Inkjet Ink]

### INTRODUCTION

An example of the method of producing the ink according to this embodiment will be described. The method of producing the ink according to this embodiment includes a dispersion step, a cross-linking step, a centrifuging step, and an ink preparation step. Note that in the method of producing the ink according to this embodiment, the centrifuging step may be omitted. Each step of the method of producing the ink according to this embodiment will be described below.

### (Dispersion Step)

In the dispersion step, dispersion treatment of dispersing a pigment and a pigment dispersion resin in an aqueous medium is performed to prepare an intermediate pigment dispersion liquid prior to cross-linking the pigment dispersion resin. In the intermediate pigment dispersion liquid, a pigment dispersion that includes a pigment, and a pigment dispersion resin adsorbed on the surface of the pigment is dispersed in water. Examples of the dispersing apparatus to be used for dispersion include a wet dispersing apparatus such as a media disperser.

The pigment dispersion resin to be used in the dispersion step is favorably subjected to neutralization treatment with a basic compound (e.g., KOH or NaOH) in advance such that the neutralization rate is 40% or more and 100% or less. Note that the neutralization rate of the pigment dispersion resin is obtained as the percentage (100×(MB/MA)) of a usage amount MB to a theoretical value MA, MA indicating the theoretical value of the amount of the basic compound necessary for completely neutralizing the pigment dispersion resin, MB indicating the actual usage amount of the basic compound in the dispersion step.

In the intermediate pigment dispersion liquid, the content of the pigment dispersion resin is favorably 4.0 mass % or more and 25.0 mass % or less. Further, in the intermediate pigment dispersion liquid, the content of the pigment is favorably 1.0 mass % or more and 30.0 mass % or less. In the dispersion step, an antifoaming agent may be blended in the intermediate pigment dispersion liquid. In the intermediate pigment dispersion liquid, the content of the antifoaming agent is favorably 0.01 mass % or more and 0.1 mass % or less.

In the dispersion step, it is favorable to remove coarse particles by filtering the intermediate pigment dispersion liquid using a filter (e.g., a pore size of 5 μm).

### (Cross-Linking Step)

In the cross-linking step, a cross-linking agent is added to the intermediate pigment dispersion liquid obtained by the dispersion step. This causes the carboxy group of the pigment dispersion resin adsorbed on the surface of the pigment and the epoxy group of the cross-linking agent to react with each other, and cross-links the pigment dispersion resin on the surface of the pigment, thereby obtaining the pigment dispersion liquid according to this embodiment. In the cross-linking step, it is favorable to stir, after adding a cross-linking agent to the intermediate pigment dispersion liquid, the intermediate pigment dispersion liquid while heating. The heating temperature can be, for example, 50° C. or more and 95° C. or less. The heating time can be, for example, 30 minutes or more and 8 hours or less.

### (Centrifuging Step)

In the centrifuging step, centrifugal treatment is applied to the pigment dispersion liquid obtained by the cross-linking step, and the supernatant liquid of the pigment dispersion liquid after centrifugal treatment is substituted with water. As a result, in the centrifuging step, the components that have been free in water in the pigment dispersion liquid can be removed. The centrifugal treatment conditions in the centrifuging step can be, for example, a rotational speed of 10000 rpm or more and 100000 rpm or less and a centrifugal treatment time of 12 hours or more and 48 hours or less.

### (Ink Preparation Step)

In the ink preparation step, a water-soluble organic solvent and water are added to the pigment dispersion liquid obtained by the centrifuging step. In this way, the ink according to this embodiment is obtained. Note that in the ink preparation step, a component (more specifically, at least one of a surfactant, a dissolution stabilizer, a moisturizing agent, a penetrating agent, a viscosity adjustor, or the like) other than the water-soluble organic solvent and water may be further added as necessary. In the ink preparation step, it is favorable to stir the obtained ink with a stirrer. Further, in the ink preparation step, foreign substances and coarse particles may be removed from the obtained ink using a filter (e.g., a filter having a pore size of 5 μm or less).

### EXAMPLES AND COMPARATIVE EXAMPLES

Inks were prepared and evaluated as Examples and Comparative Examples of the present disclosure.

### (Preparation of Ink)

The inks according to Examples and Comparative Examples were prepared as follows.

### Synthesis of Copolymer of Plurality of Specific Monomers

100.0 g of isopropyl alcohol and 250.0 g of methyl ethyl ketone were added to a four-necked flask (capacity: 1000 mL) equipped with a stirrer, a nitrogen introduction tube, a condenser, and a dropping funnel. Next, a mixed solution including a plurality of specific monomers and azobisisobutyronitrile (polymerization initiator) was set in the dropping funnel.

Nitrogen was introduced into the flask and heated to reflux at 70° C. While being heated to reflux at 70° C., the above-mentioned mixed solution was supplied to the flask from the dropping funnel over approximately 2 hours. After the mixed solution was supplied, the mixture was heated to reflux at 70° C. for 6 hours. After that, a methyl ethyl ketone solution was supplied to the flask from the dropping funnel over 15 minutes. The methyl ethyl ketone solution included 150.0 g of methyl ethyl ketone and 0.1 g of azobisisobutyronitrile. After the methyl ethyl ketone solution was supplied, the mixture was heated to reflux at 70° C. for 5 hours. Then, the content of the reaction vessel was subjected to reduction of pressure to remove the solvent, thereby obtaining a pigment dispersion resin.

Pigment dispersion resins s1 to s12 were synthesized in accordance with the above procedure. Table 1 shows specific monomers m1 to m4 used for synthesizing the pigment dispersion resins s1 to s12. The specific monomer m1 is cyclohexyl (meth)acrylate. The specific monomer m2 is (meth)acrylic acid. The specific monomer m3 is (meth)acrylic acid ester other than cyclohexyl (meth)acrylate. The specific monomer m4 is α-methylstyrene and styrene. Further, Table 1 shows the blending amount (mass %) of the specific monomer in the pigment dispersion resins s1 to s12. Further, Table 2 shows the acid value, the mass average molecular weight, and the neutralization rate for the pigment dispersion resins s1 to s12.

TABLE 1

| Specific monomer | | s1 | s2 | s3 | s4 | s5 | s6 | s7 | s8 | s9 | s10 | s11 | s12 |
|---|---|---|---|---|---|---|---|---|---|---|---|---|---|
| m1 | Cyclohexyl acrylate | 73 | 72 | 60 | 71 | 70 | | | | | 67 | 73 | 70 |
| | Cyclohexyl methacrylate | | | 12 | | | | | | 76 | | | |
| m2 | Acrylic acid | 27 | 25 | | 27 | 25 | | 28 | 26 | | 33 | 27 | |
| | Methacrylic acid | | 3 | 28 | | 4 | 27 | | | 24 | | | 27 |
| m3 | Benzyl acrylate | | | | | | | 72 | | | | | |
| | Phenoxyethyl acrylate | | | | | | | | 74 | | | | |
| | Ethylene glycol acrylate | | | | 2 | | 3 | | | | | | |
| | Dipropylene glycol acrylate | | | | | 1 | | | | | | | |
| m4 | Styrene | | | | | | 20 | | | | | | |
| | α-methylstyrene | | | | | | 40 | | | | | | |

TABLE 2

| | s1 | s2 | s3 | s4 | s5 | s6 |
|---|---|---|---|---|---|---|
| Acid value | 205 | 214 | 183 | 208 | 222 | 181 |
| (mgKOH/g) | | | | | | |
| Mass average | 9600 | 3000 | 18000 | 9700 | 9000 | 9600 |
| molecular | | | | | | |
| weight | | | | | | |
| Neutralization | 60 | 90 | 75 | 55 | 48 | 60 |
| ratio (%) | | | | | | |
| | s7 | s8 | s9 | s10 | s11 | s12 |
| Acid value | 218 | 200 | 156 | 255 | 205 | 203 |
| (mgKOH/g) | | | | | | |
| Mass average | 10000 | 10400 | 8000 | 9000 | 9600 | 30000 |
| molecular | | | | | | |
| weight | | | | | | |
| Neutralization | 55 | 65 | 45 | 60 | 30 | 65 |
| ratio (%) | | | | | | |

The mass average molecular weight of the pigment dispersion resin was measured using gel permeation chromatography (“HLC-8020GPC” manufactured by TOSOH CORPORATION) in accordance with the following conditions.
Column: “TSKgel SuperMultiporeHZ-H” manufactured by TOSOH CORPORATION (semi-microcolumn of 4.6 mm I.D.×15 cm)
Number of columns: 3
Eluent: tetrahydrofuran
Flow rate: 0.35 mL/min
Sample injection amount: 10 μL
Measurement temperature: 40° C.
Detector: IR detector

Note that the calibration curve was created by selecting seven types, i.e., F-40, F-20, F-4, F-1, A-5000, A-2500, and A-1000, and n-propylbenzene from TSKgel standard polystyrene manufactured by TOSOH CORPORATION.

Further, the acid value of the pigment dispersion resin was measured in accordance with JIS K 0070:1992 (Test methods for acid value, saponification value, ester value, iodine value, hydroxyl value and unsaponifiable matter of chemical products).

### Preparation of Intermediate Pigment Dispersion Liquid

15.0 parts by mass of a pigment, a pigment dispersion resin, 0.1 part by mass of an antifoaming agent, and ion exchanged water were mixed to obtain 100 parts by mass of a mixture. As the antifoaming agent, “SN-DEFOAMER 1340” manufactured by SAN NOPCO LIMITED was used. The obtained mixture was subjected to dispersion treatment for 4 hours using a bead mill (“DYNO (registered trademark)-MILL” manufactured by Willy A Bachofen AG) to obtain an intermediate pigment dispersion liquid. In the dispersion treatment, zirconia beads (diameter of 0.5 mm) were used as media. Further, in the dispersion treatment, the filling rate of the media in the vessel of the bead mill was 60% by volume. Further, in the dispersion treatment, the treatment temperature (chiller temperature) was set to 10° C. After the dispersion treatment, the media were removed, and then the obtained intermediate pigment dispersion liquid was filtered using a filter having a pore size of 5 μm to remove foreign substances and coarse particles.

In Examples and Comparative Examples, the following pigments p1 to p4 were used.
p1: FAST YELLOW 7413 (Sanyo Color Works, LTD.)
p2: FASTOGEN SUPER MAGENTA JM03 (DIC CORPORATION)
p3: FASTOGEN SUPER MAGENTA JM04 (DIC CORPORATION)
p4: Printex80 (Orion Engineered Carbons)

### Cross-Linking Treatment

A 1 L three-necked flask equipped with a thermometer and a stirring blade was used as a reaction vessel, and 100 g of the intermediate pigment dispersion liquid was added to the reaction vessel. Next, while maintaining the temperature inside the reaction vessel at 30° C. using a water bath, the cross-linking agent was added to the reaction vessel and sufficiently stirred. Next, the content of the reaction vessel was stirred for 1 hour at a speed of 150 rpm. Next, the cross-linking agent was added to the reaction vessel, the temperature inside the reaction vessel was raised at a heating rate of 0.5° C./min to 75° C. while stirring at 250 rpm, and the content of the reaction vessel was stirred at 250 rpm for 3 hours while maintaining the temperature inside the reaction vessel at 75° C. Then, the temperature inside the reaction vessel was cooled until reaching room temperature, thereby obtaining a pigment dispersion liquid.

In Examples and Comparative Examples, the following cross-linking agents c1 to c7 were used.
c1: DENACOL (registered trademark) EX-614B
c2: DENACOL (registered trademark) EX-313
c3: DENACOL (registered trademark) EX-421
c4: DENACOL (registered trademark) EX-512
c5: DENACOL (registered trademark) EX-521
c6: DENACOL (registered trademark) EX-612
c7: DENACOL (registered trademark) EX-145

### Preparation of Ink (Formulation q1)

60.0 mass % of a pigment dispersion liquid, 6.0 mass % of glycerin, 12.0 mass % of triethylene glycol monobutyl ether, 12.0 mass % of 3-methyl-1,5-pentanediol, 2.0 mass % of 2-pyrrolidone, 0.3 mass % of a nonionic surfactant (“OLFINEE 1004” manufactured by Nissin Chemical Co., Ltd.), and ion exchanged water (remaining amount) were stirred at a rotational speed of 400 rpm using a stirrer (“Three-One Motor BL-600” manufactured by Shinto Scientific Co., Ltd.). The obtained liquid was filtered using a filter (pore size: 5 μm).

### Preparation of Ink (Formulation q2)

60.0 mass % of a dispersion liquid, 10.0 mass % of triethylene glycol monobutyl ether, 2.0 mass % of 2-pyrrolidone, 10.0 mass % of 1,3-propanediol, 12.5 mass % of 1,5-pentanediol, 0.3 mass % of a nonionic surfactant (“OLFINEE 1004” manufactured by Nissin Chemical Co., Ltd.), and ion exchanged water (remaining amount) were stirred at a rotational speed of 400 rpm using a stirrer (“Three-One Motor BL-600” manufactured by Shinto Scientific Co., Ltd.). The obtained liquid was filtered using a filter (pore size: 5 μm).

### Preparation of Ink (Formulation q3)

60.0 mass % of a dispersion liquid, 15.0 mass % of propylene glycol, 15.0 mass % of 3-methyl-1,5-pentanediol, 0.5 mass % of a nonionic surfactant (“SURFYNOL 440” manufactured by Nissin Chemical Co., Ltd.), and ion exchanged water (remaining amount) were stirred at a rotational speed of 400 rpm using a stirrer (“Three-One Motor BL-600” manufactured by Shinto Scientific Co., Ltd.). The obtained liquid was filtered using a filter (pore size: 5 μm).

### (Evaluation of Ink)

In Examples and Comparative Examples, the preservation stability and nozzle clogging of the inks were evaluated.

### Method of Evaluating Preservation Stability

Approximately 30 g of each ink was added to a 50 mL container, and the container containing each ink was placed in a constant-temperature chamber set to 60° C. for drying treatment. In all of Examples and Comparative Examples, the drying rate calculated by the following formula was adjusted to 35%.

$$Drying rate ( \% ) = 100 - 100 \times ( weight of ink after drying / weight of ink before drying )$$

The particle size of the pigment dispersion before and after drying treatment was measured using Zetasizer (manufactured by Malvern Panalytical Ltd.), and a particle size change rate was calculated by the following formula using an initial particle size D1 before drying treatment and a post-drying particle size D2 after drying treatment, and used as an evaluation value for preservation stability.

$$Particle size change rate ( \% ) = 100 \times ( ( D 1 - D 2 ) / D 1 )$$

Using the evaluation value, evaluation was performed in the following criteria A to C. Inks with the evaluation of A for preservation stability are evaluated to “Pass”, and inks with the evaluation of B or C are evaluated to “Fail”.
A: exceeding −5% and less than +5%
B: exceeding −10% and −5% or less, or 5% or more and less than 10%
C: −10% or less or 10% or more.

### Method of Evaluating Nozzle Clogging

In the evaluation of nozzle clogging, A4-size inkjet matte paper (“Super Fine Paper” manufactured by Seiko Epson Corp.) was used as evaluation paper. An image forming apparatus (a line head-mounted inkjet recording apparatus, a tester manufactured by KYOCERA Document Solutions Inc.) was used as an evaluation device. A 150 mm×200 mm solid image was continuously printed on 100 sheets of evaluation paper by the evaluation device.

Next, the ink was purged from the recording head of the evaluation device, and then cleaning treatment was applied to the recording head by wiping the ejection surface of the recording head of the evaluation device. After that, a nozzle check pattern image was formed on evaluation paper using the evaluation device, and it was confirmed that ink was ejected from all nozzles. The cleaning treatment was applied to the recording head again, and then, the evaluation device was allowed to stand for 7 days with the recording head uncapped.

Next, the cleaning treatment was applied to the recording head again, and then, a nozzle check pattern image was formed on evaluation paper using the evaluation device. This nozzle check pattern image was checked, and the ratio of the number of non-ejection nozzles to all nozzles (7968) was calculated. The calculated ratio of the number of non-ejection nozzles was used as an evaluation value for nozzle clogging.

Using the evaluation value, evaluation was performed in accordance with the following criteria A and B. Inks with the evaluation of A for nozzle clogging are evaluated to “Pass”, and inks with the evaluation of B are evaluated to “Fail”.
A: less than 10%
B: 10% or more

### Examples 1 to 6

In Examples 1 to 6, inks were prepared by the above method such that the type of pigment, the type and content of pigment dispersion resin, the type and added amount of cross-linking agent, the cross-linking rate of the specific resin, and the ink formulation were as shown in Table 3.

TABLE 3

| | | Pigment | | Cross-linking agent | | Cross- | |
|---|---|---|---|---|---|---|---|
| | | dispersion resin | | | Added | linking | |
| | Pigment | | Content | | amount | rate | Ink |
| Example | Type | Type | (mass %) | Type | (g) | (%) | formulation |
| 1 | p1 | s1 | 4.5 | c1 | 1.2 | 40 | q1 |
| 2 | p1 | s2 | 4.5 | c2 | 1.73 | 60 | q2 |
| 3 | p2 | s3 | 4.5 | c2 | 1.11 | 45 | q2 |
| 4 | p4 | s4 | 4.5 | c3 | 1.01 | 35 | q1 |
| 5 | p2 | s5 | 4.5 | c2 | 1.94 | 65 | q2 |
| 6 | p3 | s1 | 2.5 | c1 | 1.43 | 50 | q3 |
| | | s6 | 2 | | | | |

For the inks according to Examples 1 to 6, preservation stability and nozzle clogging were evaluated. Table 4 shows the evaluation results of preservation stability and nozzle clogging for the inks according to Examples 1 to 6. In all of Examples 1 to 6, preservation stability and nozzle clogging were evaluated to “Pass”.

TABLE 4

| Preservation | |
|---|---|
| stability | Nozzle clogging |

| | | Evaluation | | Evaluation |
|---|---|---|---|---|
| Example | Evaluation | value (%) | Evaluation | value (%) |
| 1 | A | 4.9 | A | 6 |
| 2 | A | 4.8 | A | 5 |
| 3 | A | 4.5 | A | 5 |
| 4 | A | 3.2 | A | 4 |
| 5 | A | 4.6 | A | 7 |
| 6 | A | 4.5 | A | 6 |

In Comparative Examples 1 to 11, inks were prepared by the above method such that the type of pigment, the type and content of pigment dispersion resin, the type and added amount of cross-linking agent, the cross-linking rate of the specific resin, and the ink formulation were as shown in Table 3. The configurations of the inks according to Comparative Examples 1 to 11 were different from those in the above Examples. Specifically, the inks according to Comparative Examples 1 to 3 are different from the inks according to the above Examples in that cyclohexyl (meth)acrylate is not used as a specific monomer.

The ink according to Comparative Example 4 is different from the inks according to the above Examples in that the pigment dispersion resin has an acid value of less than 170 mg KOH/g. The ink according to Comparative Example 5 is different from the inks according to the above Examples in that the content of (meth)acrylic acid exceeds 30 mass % and the pigment dispersion resin has an acid value of exceeding 230 mg KOH/g. The ink according to Comparative Example 6 is different from the inks according to the above Examples in that the pigment dispersion resin has a neutralization rate of less than 40%. The ink according to Comparative Example 7 is different from the inks according to the above Examples in that the pigment dispersion resin has a mass average molecular weight of exceeding 18000.

The ink according to Comparative Example 8 is different from the inks according to the above Examples in that the number of epoxy groups in one molecule of the cross-linking agent used for cross-linking the pigment dispersion resin is one. The ink according to Comparative Example 9 is different from the inks according to the above Examples in that the cross-linking agent used for cross-linking the pigment dispersion resin has water solubility of less than 80 mass %. The ink according to Comparative Example 10 is different from the inks according to the above Examples in that the specific resin has a cross-linking rate of less than 30%. The ink according to Comparative Example 11 is different from the inks according to the above Examples in that the specific resin has a cross-linking rate of exceeding 70%.

TABLE 5

| | | | | Cross-linking agent | | Cross- | |
|---|---|---|---|---|---|---|---|
| | | Resin | | | Added | linking | |
| Comparative | Pigment | | Content | | amount | rate | Ink |
| Example | Type | Type | (mass %) | Type | (g) | (%) | formulation |
| 1 | p2 | s7 | 4.5 | c2 | 1.76 | 60 | q1 |
| 2 | p2 | s8 | 4.5 | c2 | 1.35 | 50 | q2 |
| 3 | p1 | s6 | 4.5 | c1 | 1.93 | 35 | q2 |
| 4 | p4 | s9 | 4.5 | c2 | 1.26 | 60 | q3 |
| 5 | p2 | s10 | 4.5 | c3 | 1.24 | 35 | q2 |
| 6 | p4 | s11 | 4.5 | c2 | 1.66 | 60 | q1 |
| 7 | p2 | s12 | 4.5 | c2 | 1.79 | 65 | q2 |
| 8 | p1 | s1 | 4.5 | c4 | 0.81 | 30 | q1 |
| 9 | p2 | s2 | 4.5 | c5 | 2.75 | 40 | q2 |
| 10 | p1 | s3 | 4.5 | c2 | 0.61 | 25 | q2 |
| 11 | p3 | s1 | 4.5 | c2 | 2.21 | 80 | q1 |

For the inks according to Comparative Examples 1 to 11, preservation stability and nozzle clogging were evaluated. Table 6 shows the evaluation results of preservation stability and nozzle clogging for the inks according to Comparative Examples 1 to 11. In the inks according to Comparative Examples 1 to 5 and 7 to 11, at least one of preservation stability or nozzle clogging was evaluated to “Fail”. Further, in the ink according to Comparative Example 6, since the pigment dispersion was not sufficiently dispersed in the aqueous medium, and thus, preservation stability and nozzle clogging could not be evaluated.

TABLE 6

| | Preservation | | | |
|---|---|---|---|---|
| | stability | | Nozzle clogging | |
| Comparative | | Evaluation | | Evaluation |
| Example | Evaluation | value (%) | Evaluation | value (%) |
| 1 | C | 11.0 | B | 21 |
| 2 | C | 54.0 | B | 31 |
| 3 | B | 9.5 | B | 13 |
| 4 | A | 4.7 | B | 15 |
| 5 | C | 14.0 | B | 23 |
| 6 | — | — | — | — |
| 7 | A | 4.1 | B | 15 |
| 8 | C | 65.0 | B | 32 |
| 9 | C | 120.0 | B | 42 |
| 10 | C | 46.0 | B | 29 |
| 11 | A | 3.8 | B | 17 |

It should be understood by those skilled in the art that various modifications, combinations, sub-combinations and alterations may occur depending on design requirements and other factors insofar as they are within the scope of the appended claims or the equivalents thereof.

What is claimed is:

1. A pigment dispersion liquid, comprising:
an aqueous medium; and
a pigment dispersion dispersed in the aqueous medium,
the pigment dispersion including a pigment and a specific resin,
the specific resin having a cross-linked structure in which a pigment dispersion resin including a copolymer of a plurality of specific monomers is cross-linked by a cross-linking agent,
the plurality of specific monomers including 60 mass % or more and 80 mass % or less of cyclohexyl (meth)acrylate and 22 mass % or more and 30 mass % or less of (meth)acrylic acid,
the copolymer of a plurality of specific monomers having an acid value of 170 mg KOH/g or more and 230 mg KOH/g or less, a neutralization rate of 40% or more and 100% or less, and a mass average molecular weight of 3000 or more and 18000 or less,
the cross-linking agent including a plurality of epoxy groups and at least one hydroxy group in one molecule and having water solubility of 80 mass % or more, and
the specific resin having a cross-linking rate of 30% or more and 70% or less.

2. The pigment dispersion liquid according to claim 1, wherein
the pigment dispersion resin further includes a styrene-(meth)acrylic acid copolymer.

3. The pigment dispersion liquid according to claim 2, wherein
the styrene-(meth)acrylic acid copolymer is a copolymer of α-methylstyrene, styrene, (meth)acrylic acid, and a nonionic monomer.

4. The pigment dispersion liquid according to claim 1, wherein
the plurality of specific monomers further includes (meth)acrylic acid ester other than cyclohexyl (meth)acrylate.

5. An inkjet ink, comprising:
the pigment dispersion liquid according to claim 1.

6. A method of producing a pigment dispersion liquid, comprising:
a dispersion step of dispersing a pigment and a pigment dispersion resin in an aqueous medium to prepare an intermediate pigment dispersion liquid; and
a cross-linking step of preparing a pigment dispersion liquid by adding a cross-linking agent to the intermediate pigment dispersion liquid and cross-linking the pigment dispersion resin on a surface of the pigment to obtain a specific resin;
the pigment dispersion resin including a copolymer of a plurality of specific monomers,
the plurality of specific monomers including 60 mass % or more and 80 mass % or less of cyclohexyl (meth)acrylate and 22 mass % or more and 30 mass % or less of (meth)acrylic acid,
the copolymer of a plurality of specific monomers having an acid value of 170 mg KOH/g or more and 230 mg KOH/g or less, a neutralization rate of 40% or more and 100% or less, and a mass average molecular weight of 3000 or more and 18000 or less,
the cross-linking agent including a plurality of epoxy groups and at least one hydroxy group in one molecule and having water solubility of 80 mass % or more, and
the specific resin having a cross-linking rate of 30% or more and 70% or less.

7. The method of producing the pigment dispersion liquid according to claim 6, further comprising a centrifuging step of applying centrifugal treatment to the pigment dispersion liquid after the cross-linking step.

8. The method of producing the pigment dispersion liquid according to claim 6, further comprising
the pigment dispersion resin has a neutralization rate of 40% or more and 100% or less.

9. A method of producing an inkjet ink, comprising:
a dispersion step of dispersing a pigment and a pigment dispersion resin in an aqueous medium to prepare an intermediate pigment dispersion liquid;
a cross-linking step of preparing a pigment dispersion liquid by adding a cross-linking agent to the intermediate pigment dispersion liquid and cross-linking the pigment dispersion resin on a surface of the pigment to obtain a specific resin; and
an ink preparation step of adding a water-soluble organic solvent and water to the pigment dispersion liquid to prepare an inkjet ink,
the pigment dispersion resin including a copolymer of a plurality of specific monomers,
the plurality of specific monomers including 60 mass % or more and 80 mass % or less of cyclohexyl (meth)acrylate and 22 mass % or more and 30 mass % or less of (meth)acrylic acid,
the copolymer of a plurality of specific monomers having an acid value of 170 mg KOH/g or more and 230 mg KOH/g or less, a neutralization rate of 40% or more and 100% or less, and a mass average molecular weight of 3000 or more and 18000 or less,
the cross-linking agent including a plurality of epoxy groups and at least one hydroxy group in one molecule and having water solubility of 80 mass % or more, and
the specific resin having a cross-linking rate of 30% or more and 70% or less.
